(19) United States
(12) Patent Application Publication
(10) Pub. No.: US 2024/0174775 A1
(43) Pub. Date: May 30, 2024

(54) Ultra-Tough Hydrogel via Hierarchical Energy Associative Dissipation

(71) Applicant: BEIJING UNIVERSITY OF TECHNOLOGY, BEIJING (CN)

(72) Inventors: Zhi Zhao, BEIJING (CN); Xiaoyan Song, BEIJING (CN); Haibin Wang, BEIJING (CN); Yurong Li, BEIJING (CN); Yupeng Shan, BEIJING (CN); Xuan Yao, BEIJING (CN)

(21) Appl. No.: 18/513,222

(22) Filed: Nov. 17, 2023

(30) Foreign Application Priority Data
Nov. 24, 2022 (CN) 202211497335.X

(51) Int. Cl. C08F 20/06

(52) U.S. Cl. CPC C08F 20/06; C08F 2810/10

(57) ABSTRACT

An ultra-tough physical hydrogel based on hierarchical energy associative dissipation network is provided, which the field of polymeric materials. The stock solution of a hydrogen donor is prepared by dissolving the hydrogen donor in deionized water; the stock solution is mixed with a hydrogen acceptor, deionized water and a 10 wt % ammonium persulfate (APS) solution; the mixture is cured in a closed container; after reactants with specific functional groups and appropriate spatial structures are mixed, a hierarchical heterogeneous structure with a dynamic recovery capability can be spontaneously formed in polymerization reaction, and the mechanical properties of the hydrogel are kept stable through several energy associative dissipation paths.

### CROSS-REFERENCE TO RELATED APPLICATION

The present application claims priority benefit to Chinese Patent Application No. 202211497335.X, filed on Nov. 24, 2022, the entire contents of which are incorporated herein by reference.

### BACKGROUND OF THE INVENTION

### 1. Technical Field

The present invention relates to a method for introducing hierarchical energy associative dissipation network into hydrogel materials, and a method for efficiently preparing ultra-tough physical hydrogels based on such network which belongs to the field of polymeric materials.

### 2. Background

Hydrogels are widely used in many fields such as biomedicine, smart materials, chemical sensors, wearable devices, energy storage, and structural materials. In practical applications, the mechanical properties of hydrogels often have a greater influence on the comprehensive performance of materials than their physical and chemical properties because real application scenarios often involve extreme conditions such as long-term service, repeated impact and severe deformation. In those cases, the mechanical stability of the hydrogels is critical to proper functioning of the hydrogels.

The mechanical properties of hydrogels are usually poorer than that of other materials, which is determined by their structural characteristics. Conventional hydrogels are homogeneous crosslinked polymeric networks containing a significant portion of water molecules. The deficiency of solid substances and the lack of functional units that can support energy associative dissipation in the structure make their ability to resist external forces and deformation poor and their hardness and toughness unsatisfying. To address the issue, a number of approaches for strengthening and toughening the hydrogels have been proposed in previous studies. One popular idea is to incorporate tensile-resistant units such as micellar crosslinkers, force responsive groups, peptide crosslinkers, covalent organic frameworks, and ionic crosslinking points into hydrogel, which absorb energy during mechanical deformation. Alternatively, introducing structural heterogeneity via molecular rearrangement is another feasible solution. Phase separation, partial polymer crystallization and polymer alignment could take place upon thermal annealing, freezing-thawing or geometric constraint, leading to heterogeneous texture in hydrogel. The formation of alternating stiff and elastic domains enhances hydrogel's comprehensive performance. By employing multiple strengthening methods, it is possible to further boost the mechanical performance of hydrogels. The mechanical properties of the hydrogels are possibly further improved by using the above methods in combination.

Nevertheless, many limitations still exist for current methods. The development of tensile-resistant groups usually requires extensive organic synthesis, which causes increased experimental complexity and cost. Post-fabrication treatment is a necessity for the rearrangement of polymers. Not only does it consume additional time, but it also has compatibility issues. Bulky, mechanically unstable and irregularly shaped objects, for example, would be very difficult to treat properly. Due to the irreversible nature of many force responsive groups and treating processes, a great portion of existing ultra-tough hydrogels do not possess self-healing abilities, which has negative impaction their working lifetime and long-term mechanical stability. Last but not least, previous examples were all developed on a try-and-error base. There lacks a universal strategy to rationally design super robust hydrogels in a demand oriented fashion.

To address the above issues, the present invention discloses a method for designing and preparing a novel ultra-tough physical hydrogel. In the method, a unique polymer self-assembly system is used to construct a technology to enhance the toughness of the hydrogel with a mutually coupled hierarchical energy associative dissipation structure. After reactants with specific functional groups and appropriate spatial structures are mixed, a hierarchical heterogeneous structure with the dynamic recovery capability can be spontaneously formed in polymerization reaction, and the mechanical property of the hydrogel is kept stable through several energy associative dissipation paths. The method can be used to directly prepare desired materials in one pot without depending on the special reactants or the post-treatment technologies; the obtained hydrogels have extremely excellent and flexible mechanical properties, such as material properties, the tensile strength can be adjusted within the range of 150 kPa-20 MPa, the maximum rupture deformation can reach 30,000%, and the rupture strength can reach 136 MJ/m³. The above property indicators and the comprehensive performance of the materials are at the international leading level.

### BRIEF SUMMARY OF THE INVENTION

The present invention proposes a method for establishing hierarchical energy associative dissipation network in hydrogels. The method allows polymer chains to spontaneously form a mutually coupled hierarchical self-assembly network by precisely matching the types, spatial arrangements and relative molar ratios of groups involving in the formation of hydrogen bonds and hydrophobic interactions (FIG. 1). Self-assembly networks are based on non-covalent interactions between molecules, and thus their formation has good reversibility and dynamic stability. These non-covalent interactions can be used as physical crosslinking sites to strengthen ultra-tough physical hydrogels. A large amount of energy is dissipated to destroy the physical crosslinking sites during the deformation of the materials. Because molecular coupling exists among the self-assembly networks at all levels, energy can be dissipated synergistically. It is necessary to break all non-covalent interactions of the material when the macroscopic structure of the material is destroyed, which greatly improves the tensile strength of the material. The reversibility of the formation of the self-assembly networks enables them to recover quickly after being damaged. During deformation, local micro-cracks or localized ruptures, if any, can be spontaneously repaired to realize repeated generation of the self-assembly networks and dynamically maintain the continuity and integrity of the materials, which greatly improves the toughness and the maximum deformation of the materials. The materials can absorb the energy of external loads repeatedly through the dynamic hierarchical energy associative dissipation structure before final rupture, thus having both high strength and toughness.

The formation mechanism of the hierarchical self-assembly network is as follows:

(1) Zipper like core. The zipper like core is the primary self-assembly structure and formed mainly on hydrogen bonding among hydrogen donors and hydrogen acceptors. The hydrogen-bond interaction is the molecular basis for the formation of physical hydrogels. The hydrogen donor used in the present invention is acrylic acid and its derivatives, including acrylic acid (AAc), methacrylic acid (MAAc), and 2-fluoroacrylic acid (FAAc); the hydrogen acceptor used is micromolecule organic amine, including ethylenediamine (EDA), N, N-dimethylethylenediamine (DMED), N,Nº-dimethyl-1,2-ethanediamine (MMED), N,N,N′-trimethylethylenediamine (DMMED), tetramethylethylenediamine (TEMED), N,N,N′,N′-tetraethylethylenediamine (TEEED), N,N,N′,N′-tetramethyl-1,3-propanediamine (TEMPD), diethylenetriamine (DETA), N,N,N′,N″,N″-pentamethyldiethylenetriamine (PMDETA), N,N,N′,N′-tetraethyldiethylenetriamine (TEDETA), 1,1,4,7,10,10-hexamethyltriethylenetetramine (HMTETA), pentaethylenehexamine (PEHA), Cis-cyclohexane-1,2-diamine (cis-CHDA), and trans-cyclohexane-1,2-diamine (trans-CHDA).

The formation of the zipper like core requires the specific arrangement of functional groups of the hydrogen donor and the hydrogen acceptor (FIG. 2). Adjacent carboxyl groups on a polymer chain need to be spaced by three carbon atoms. The amine groups of hydrogen acceptors need to be spaced by two carbon atoms. The specific molecular architecture above allows the formation of a sliding wedge structure containing multidentate hydrogen bonding that simultaneously enables high-strength molecular interactions and great deformability.

Hydrogen-bond interaction that does not satisfy the characteristic spatial structure required to form the zipper like core cannot function to maintain the stability of supramolecular assembly. The formation of the zipper structure requires that the hydrogen acceptor necessarily includes a sliding wedge structure, namely a 1,2-bifunctional moiety. Acceptors and donors with only a single hydrogen bonding site are greatly reduced in the interaction strength and are unable to effectively gelated. In addition, the spacing between the amine groups is important, and the arrangement of the 1,2-bifunctional moiety shows the highest stability. This is due to the fact that the additional stabilization energy can be obtained through forming multi-member ring with a limited size. As the distance between adjacent hydrogen acceptors increases, the stabilization effect from forming larger multi-member ring disappears. The formation of the zipper structure also requires that the hydrophobic groups on the hydrogen donor (if any) and the carboxyl groups must be attached to a same carbon atom. This is due to the fact that the carboxyl groups are all on a same side of the polymer chain when forming the chain arrangement and form hydrogen bonds with the amine groups (FIG. 2), whereby squeezing water molecules to the other side of the molecular chain. When the hydrophobic groups and the carboxyl groups are attached to different carbon atoms, the hydrophobic groups will face opposite sides of the carboxyl groups and be directly exposed to the aqueous solution, thereby being thermodynamically unstable.

The bonding strength between the sliding wedge and the chain is influenced by the hydrogen-bond interaction strength and the neighboring substituting groups. When an electron-withdrawing group exists on the hydrogen donor or an electron-donating group exists on the hydrogen acceptor, hydrogen bonds formed have higher strength. Accordingly, the zipper like core is easy to form. When the group involved in the formation of the hydrogen bonds has a hydrophobic group on its own or in its neighboring sites, it can hinder the attack of water molecules on the hydrogen bonds, thereby stabilizing a hydrogen bonding structure in a solution and promoting the formation of the zipper like core. As the number of included amine groups increases, the bonding strength of the sliding wedge hydrogen acceptor and the carboxyl chain will be increased accordingly.

Two amine groups in the sliding wedge structure are kinetically more likely to initiate gelation reaction when located in the trans-configuration because the geometric matching relationship between the sliding wedge structure and the chain is better in with such configuration. In addition, since a C—C single bond in the polymer chain can rotate, a spatial positional relationship between the neighboring carboxyl groups can vary within a specific range, thereby better matching the sliding wedge with a cis-diamine structure. Therefore, both cis-diamine and trans-diamine structures can initiate the gelation reaction and the final mechanical properties of the products thereof are equivalent. If the spatial arrangements of the amine groups and the carboxyl groups cannot match with each other through rotation of the C—C single bond for any reason, the gelation reaction will be severely hindered.

(2) Hydrophobic domains: the hydrophobic groups in the reaction system can be clustered through hydrophobic interactions and assembled into a supramolecular structure, i.e. a hydrophobic domain, with a considerable associative strength, which can turn the hydrogel from a homogeneous structure into a heterogeneous structure. The hydrophobic domains are usually submicron-sized spheres or spheroids containing closely packed organic molecules, and therefore has a higher material density than surrounding media.

A proper density of the sliding wedge needs to be provided for the formation of the hydrophobic domains (FIG. 3). The combination of the sliding wedge and the chain reduces the hydration tendency of the carboxyl groups and the amine groups, and causes the hydrophobic groups to be concentrated within a relatively fixed spatial range, which is more likely to produce the hydrophobic interaction. The proper density of the sliding wedge can facilitate the self-assembly of the hydrophobic groups within a relatively large range, thus forming an observable phase. In addition, because the formation of the hydrophobic domains is determined by the specific proportion of hydrophilic groups, an excessively high density of the sliding wedge will inhibit the formation of hydrophobic domains. The hydrophilic groups can enclose the hydrophobic domains therein to achieve thermodynamic stability in the aqueous solution. When most of the carboxyl groups are bonded with the amine groups, the reaction system lacks free hydrophilic groups, and the polymer chains present hydrophobicity, and are exposed to aqueous environment and in a thermodynamic unfavorable state. At the same time, the pH of the reaction system will increase with the increase of the amine concentration, and the non-covalent hydrogen-bond interaction between the carboxyl groups and the amine groups will be transformed into the ammonium-carboxylate ionic bond, thereby greatly improving the hydrolysis tendency thereof and reducing the possibility to form the self-assembly network.

The existence of the hydrophobic groups can greatly facilitate the formation of the hydrophobic domains because the existence of the hydrophobic domains depend on the hydrophobic interaction. Their formation is also influenced by the intermolecular hydrogen bonding strength. The strong hydrogen-bond interaction indicates a short distance between molecules, facilitating the hydrophobic self-assembly. Hydrophobic groups that are located on the amine groups and adjacent to the carboxyl groups have different effects on the phase separation. Amine molecules with the sliding wedge structure are at the core during the phase separation, the hydrophobic groups thereon can make the phase separation be easily induced, and the hydrophobic self-assembly process is regulated in a large spatial range, thus reducing the concentration of the sliding wedge required for the phase separation. However, at the high concentration of the sliding wedge, neighboring amine groups may compete for hydrophobic units, which makes the phase separation difficult. The carboxyl chain surrounds the core of the sliding wedge during the phase separation, thus stabilizing a hydrophobic structure. The existence of the hydrophobic groups adjacent to the carboxyl groups can improve the stability of the hydrophobic domains and make the phase separation easier. At the same time, the carboxyl chain with good hydrophobicity can stabilize the hydrophobic domains with a short chain length. Therefore, the carboxyl chain can accommodate more sliding wedge cores to expand the concentration range of amine groups suitable for hydrophobic self-assembly.

The existence of the hydrophobic domains is not the key factor determining whether the physical hydrogel can be formed. However, their existence can greatly improve the tensile strength of the hydrogel because the hydrogel with the hydrophobic domains needs to dissipate extra energy to destroy hydrophobic bonding during deformation.

(3) Formation of an advanced structure through assembly of the hydrophobic domain. Spherical hydrophobic domain matrices are further assembled into a complex advanced structure with a larger volume. The intermolecular hydrogen bonding and the further cluster of the hydrophobic groups are the main driven force of the process.

The types of the advanced structures assembled by the hydrophobic domains include large particles, network structures, fibrous structures, and other structures. The formation of the advanced structure further improves the mechanical properties of the hydrogels because more extra energy is needed to destroy the advanced structure. The existence of the advanced structure is greatly influenced by the hydrogen bonding strength, and the type, number, and distribution of the hydrophobic groups. When the hydrogen bonding strength is large, and the hydrophobic groups are large in volume and numerous and densely distributed on both the hydrogen donor and the hydrogen acceptor, the advanced structure is formed to a greatest extent.

Although the formation of the advanced structure has the reversibility as the hydrophobic domain and the zipper like core, its dynamic process is relatively slow because the formation of advanced structures requires the orderly participation of a large number of groups (FIG. 4). Therefore, the mechanical properties of the advanced structure will be sensitive to the tensile speed of the material, so that the material can exhibit unique dynamic property characteristics.

To obtain the ultra-tough hydrogel with the optimal comprehensive performance, it is necessary to balance and coordinate the relative strengths of three energy associative dissipation structures to maximize their synergistic efficacy during the deformation of the materials, and to better stabilize the materials through coupled energy associative dissipation. If the stability of one structure is obviously incompatible with that of other structures, the hydrogel may have insufficient stability and undesired hardness, strength or toughness. In the hierarchical self-assembly network, the zipper like core has the optimal elasticity and can slide to resist large-scale deformation, but it also has the lowest strength; the hydrophobic domains have moderate strength and elasticity; the advanced structure has extremely high strength, but it also has the undesired deformability. If the three structures are represented by a spring model (FIG. 5), a stiffness coefficient satisfies k₁<<k₂<<k₃. In order to achieve the same deformation as the zipper like core, a plurality of hydrophobic domains and the advanced structure need to be attached and cooperate each other, and their connection sites are indicated by dotted lines in FIG. 5a. The hydrogel with insufficient hydrophobic domains can only resist deformation through the sliding of the zipper like core. Although the hydrogel has good elasticity, its strength is very low. In a hydrogel with excessively strong hydrophobic interaction, each structural unit is prone to generate strong bonding therein, but there is no interaction between the structures, and only some units participate in strain under an external force. Such a hydrogel can reach high strength, but it cannot deform within a large range; and when the hierarchical structures have a proper density and interact sufficiently, the hydrogel can exhibit excellent strength and elasticity.

The matching principle of reactants in the design of the ultra-tough hydrogel is as follows:

(1) When the hydrogen donor and the hydrogen acceptor have similar hydrophobicity, the strength of the hydrogel is high.

(2) When the hydrogen donor and the hydrogen acceptor have different hydrophobicity, the elasticity of the hydrogel is improved and the tensile strength of the hydrogel is reduced because the hydrophobicity mismatching decreases the strength of the hydrophobic domains and the zipper like core plays a major role in the material.

(3) When the same type of the hydrogen acceptor is lengthened, the strength and elasticity of the hydrogel are greatly improved.

A method for preparing an ultra-tough physical hydrogel includes the following steps:

(1) preparing the stock solution of a hydrogen donor: dissolving a hydrogen donor in deionized water, where the mass concentration of the stock solution is adjusted according to desired properties of materials and generally 25%-50%.

(2) mixing all reactants in an appropriate proportion: mixing the stock solution with a hydrogen acceptor, deionized water and a 10 wt % ammonium persulfate (APS) solution, and the molar ratio of the hydrogen donor to the hydrogen acceptor in the final mixture ranges from 9:1 to 5:6.

The mixing ratio of the reaction mixture is adjusted according to the desired properties of materials and for 1 mL of the stock solution, 0-190 μL of the deionized water, 10-200 μL of the hydrogen acceptor, and 100 μL of 10% ammonium persulfate (APS) solution may be added.

(3) incubation: placing the mixture in a closed container until it is fully cured. The incubation time varies greatly according to different formulations, and is generally 5 min to 2 d; if a hydrogel with a specific shape needs to be prepared, the mixture is poured into the corresponding mold, and cured.

The ultra-tough hydrogel can be prepared in one pot through the above method, without any additional steps. The method has the outstanding advantages of operation convenience, fast preparation, good controllability and reproducibility, and low overall cost. The hardness, elasticity and toughness of the prepared hydrogel have reached the international leading level, and can be adjusted within a wide range according to the actual demand. As compared to the existing preparation methods for improving the toughness of the hydrogel through organic synthesis, drug immersion, high and low temperature treatment and the like, the unique method for generating the hierarchical energy associative dissipation network through self-assembly polymers according to the present invention is more efficient and simpler, applicable to the majority of the hydrogel geometry and performance requirements, and especially suitable for mass production and industrial application.

### BRIEF DESCRIPTION OF THE SEVERAL VIEWS OF THE DRAWINGS

FIG. 1 is a schematic structural diagram of a hydrogel with a hierarchical energy associative dissipation network.

FIG. 2 is a schematic diagram of an interaction principle of a zipper like core. (a) Materials are subjected to an external force; (b) some hydrogen bonds are ruptured and polymer chains rotate; and (c) a new zipper like core is reformed.

FIG. 3 is a schematic diagram of the influence of the density of a sliding wedge on a hydrophobic domain. (a) Low density of sliding wedge; (b) proper density of sliding wedge; and (c) high density of sliding wedge.

FIG. 4 is a schematic diagram of dynamic characteristics of formation of hierarchical structures. (a) Zipper like core; (b) hydrophobic domain; (c) advanced structure.

FIG. 5 shows an equivalent spring model of the influence of a hierarchical energy associative dissipation structure on the mechanical properties of the hydrogel. (a) Schematic diagram of an equivalent spring model; and (b) formation mechanism of typical properties of the hydrogel.

FIG. 6 shows the influence of the number of amine groups in Example 1 on system gelation.

FIG. 7 shows the influence of a distance between amine functional groups in Example 1 on system gelation.

FIG. 8 shows the influence of the position of hydrophobic groups in Example 1 on system gelation.

FIG. 9 shows the influence of the intermolecular hydrogen bonding strength and stability in Example 1 on system gelation. (A) Intermolecular hydrogen bonding strength system gelation; and (B) intermolecular hydrogen bonding stability system gelation.

FIG. 10 shows the influence of a structural length of a sliding wedge in Example 1 on system gelation.

FIG. 11 shows the influence of the arrangement of amine groups in Example 1 system gelation. (A) Images of gelation of MAAc with cis-CHDA and trans-CHDA; (B) analysis of gelation rate of MAAc with cis-CHDA and trans-CHDA; (C) analysis of gelation tensile of MAAc with cis-CHDA and trans-CHDA; and (D) gelation test of AAc and MAAc with hexamethylenetetramine (HMTA).

FIG. 12 shows evidence and conditions for the existence of hydrophobic interaction and phase separation in Example 2. (A) Images of AAc-TEMED hydrogel with different addition amounts of TEMED; (B) fluorescence micrographs of typical AAc-TEMED hydrogel; (C) SEM images of typical AAc-TEMED hydrogel; (D) infrared spectra of AAc-TEMED hydrogel with different addition amounts of TEMED; and (E) change in pH of AAc-TEMED precursor with different addition amounts of TEMED.

FIG. 13 shows a main factor affecting phase separation in Example 2. (A) Concentration range of phase-separated amine groups when AAc is gelatinized with hydrogen acceptors with different chain lengths; (B) concentration range of phase-separated amine groups when AAc is gelatinized with hydrogen acceptors with different hydrophobic groups; (C) concentration range of phase-separated amine groups when MAAc is gelatinized with different hydrogen acceptors; (D) concentration range of phase-separated amine groups when FAAc is gelatinized with different hydrogen acceptors.

FIG. 14 shows the influence of hydrophobic domains in Example 2 on mechanical properties of materials.

FIG. 15 shows an advanced structure self-assembled by hydrophobic domains in Example 3. (A) Large particles; (B) network structures; and (C) fibrous structures.

FIG. 16 shows dynamic characteristics of an advanced hydrophobic structure in Example 3 and influence of the advanced hydrophobic structure on mechanical properties of the hydrogel.

FIG. 17 shows a preparation example of an ultra-tough hydrogel with different performance characteristics in Example 4. (A)-(C) Tensile curves of several ultra-tough hydrogels; (D) macroscopic and microscopic images of ultra-high elastic hydrogels.

FIG. 18 shows an application example of a design principle of an ultra-tough hydrogel in Example 4.

FIG. 19 shows a test on preparation of a hydrogel with a chemical crosslinker in Comparative Example 1.

FIG. 20 shows a test on preparation of a hydrogel with amide as a hydrogen acceptor in Comparative Example 2.

### DETAILED DESCRIPTION OF THE INVENTION

The present invention is further described below with reference to examples, but the present invention is not limited to the following examples.

### Example 1

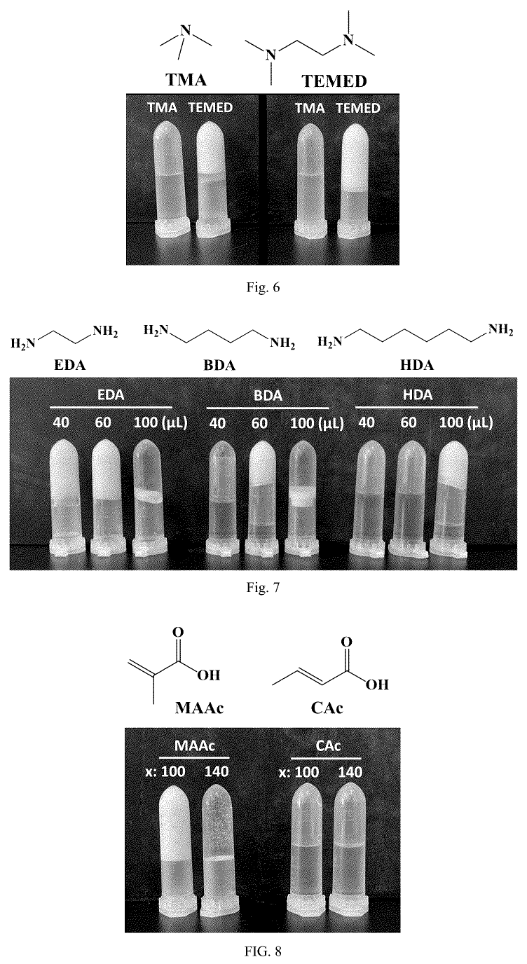

140 μL of water, 100μ1 of 10% APS, and 60 μL of trimethylamine (TMA) or TEMED were added into 1 mL of AAc with a mass fraction of 28.6%, and only the AAc added with TEMED could form a hydrogel; and 140 μL of water, 100 μL of 10% APS, and 60 μL of TMA or TEMED were added into 1 mL of MAAc with the mass fraction of 32.3%, and only the MAAc added with TEMED could form a hydrogel (FIG. 6). TMA, as a comparative example, proves that amines with a single hydrogen acceptor cannot be effectively gelatinized.

x μL of EDA, 1,4-butanediamine (BDA) or 1,6-hexanediamine (HDA) and (200-x) μL of water were added into 1 mL of MAAc with the mass fraction of 32.3%, where x=40, 60 or 100; and then 100μ1 of 10% APS was added. The minimum concentrations of amine molecules required for complete gelation of EDA, BDA and HDA added systems increased sequentially, where the HDA added system could not be completely gelatinized in the presence of high-concentration amine molecules (FIG. 7). As a comparative example, BDA and HDA prove that the arrangement of the 1,2-bifunctional matrix shows the highest gelation stability.

x μL of TEMED and (200-x) μL of water were added into 1 mL of MAAc with the mass fraction of 32.3%, where x=100 or 140; and then 100 μL of 10% APS was added. x μL of TEMED and (200-x) μL of water were added into 1 mL of crotonic acid (CAc) with the mass fraction of 32.3%, where x=100 or 140; and then 100 μL of 10% APS was added. The MAAc added systems were completely gelatinized. As a comparative example, the CAc added system could not be gelatinized. (FIG. 8). It is noted that MAAc and CAc are isomers, proving that it is necessary to attach hydrophobic groups and carboxyl groups to a same carbon atom for gelation.

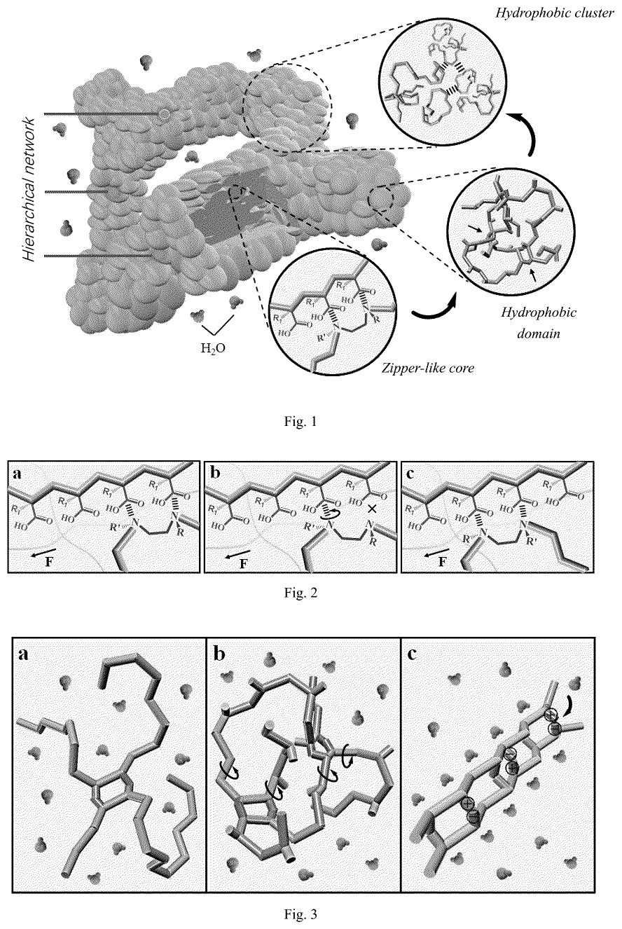

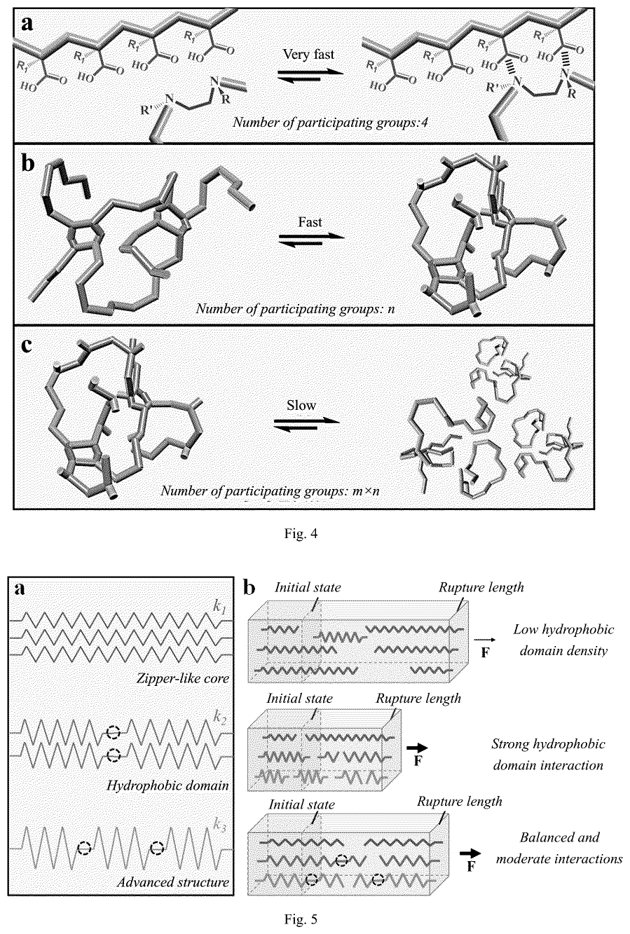

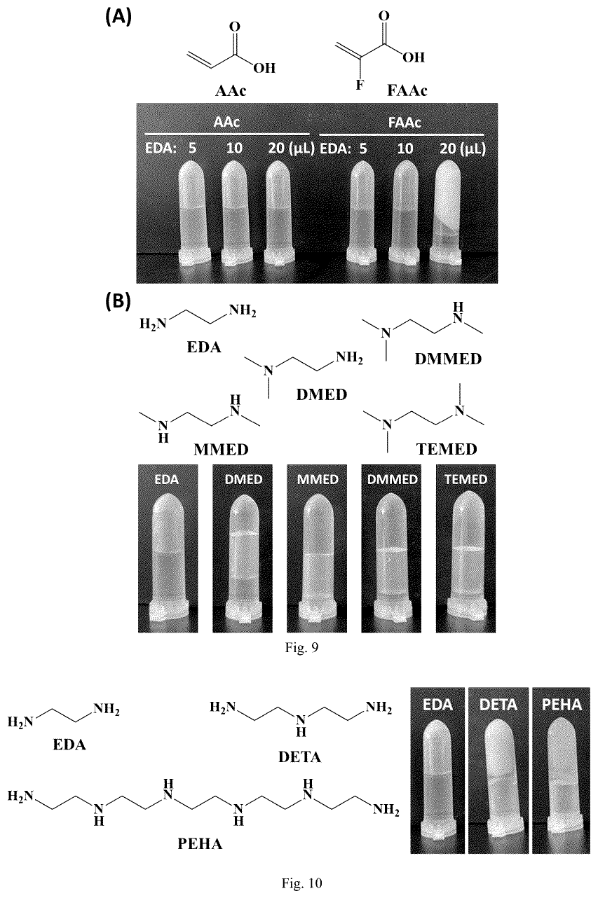

x μL of EDA and (200-x) μL of water were added into 1 mL of AAc with the mass fraction of 28.6%, where x=5, 10 or 20; and then 100 μL of 10% APS was added. x μL of EDA and (200-x) μL of water were added into 1 mL of FAAc with the mass fraction of 33.3%, where x=5, 10 or 20; and then 100 μL of 10% APS was added. It can be seen that all AAc added systems cannot be gelatinized; however, the FAAc added system can be gelatinized at x=20, indicating that high-strength hydrogen bonds are helpful to gelation (FIG. 9A). 0.2 mmol of EDA, DMED, MMED, DMMED and TEMED were added into 1 mL of AAc with the mass fraction of 28.6% respectively, and then 100 μL of 10% APS and a proper amount of deionized water were added, such that the final volume of all solution systems was 1.3 mL. After the solution system stood for 1 day, it was found that the EDA added system could not be gelatinized, and the DMED added system was terribly gelatinized, while the system added with MMED, DMMED and TEMED could be well gelatinized (FIG. 9B). The above tests prove that the methyl group on N enhances the hydrogen bonding stability, and the existence of the methyl group is conductive to gelation reactions. At the same time, it can be seen that MMED has a better gelation property than DMED, thereby further proving that the gelation process in the present invention depends on the multidentate bonding zipper like core (FIG. 1). The addition of methyl to only one N atom cannot greatly improve the gelation stability.

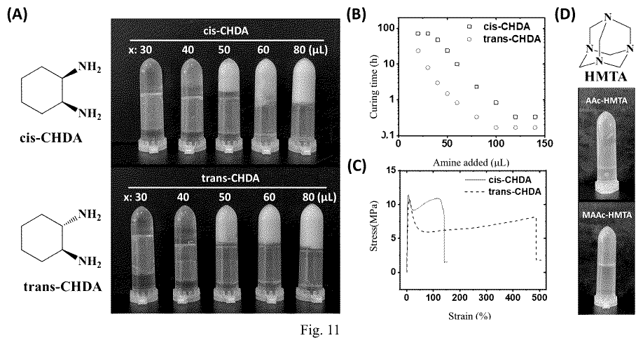

20 μL of EDA, DETA and PEHA were added into 1 mL of AAc with the mass fraction of 28.6% respectively, and then 180 μL of water and 100 μL of 10% APS were added. After incubation, the system added with EDA could not be gelatinized, but the systems added with DETA and PEHA could be gelatinized, and the system added with PEHA could be more completely gelatinized (FIG. 10), proving that the gelation efficiency can be improved by increasing the structural length of the sliding wedge.

x μL of cis-CHDA and (200-x) μL of water were added into 1 mL of MAAc with the mass fraction of 32.3%, where x=30, 40, 50, 60 or 80; and then 100 μL of 10% APS was added. x μL of trans-CHDA and (200-x) μL of water were added into 1 mL of MAAc with the mass fraction of 32.3%, where x=30, 40, 50, 60 or 80; and then 100 μL of 10% APS was added. The above systems stood for one week to completely achieve gelation reaction. It can be observed that the gelation of the systems added with cis-CHDA and trans-CHDA is almost identical (FIG. 11A), proving that there is no difference in the thermodynamic behavior of cis-trans isomers. In addition, the gelation rates of the systems added with cis-CHDA and trans-CHDA differ significantly. The system added with trans-CHDA has a gelation rate more than three times faster than the system added with cis-CHDA (FIG. 11B). This proves that the most favorable arrangement for the formation of the zipper like core was the trans arrangement. 80 μL of cis-CHDA and 120 μL of water were added into 1 mL of MAAc with the mass fraction of 48.9%, and then 100 μL of 10% APS was added. 80 μL of trans-CHDA and 120 μL of water were added into 1 mL of MAAc with the mass fraction of 48.9%, and then 100 μL of 10% APS was added. Tensile tests show that the tensile strength of the hydrogel with trans-CHDA is slightly less than that of the hydrogel with cis-CHDA, but the rupture tensile rate of the hydrogel with trans-CHDA is much greater than that of the hydrogel with cis-CHDA (FIG. 11C), indicating that the tensile strength mainly depends on the bonding strength of intermolecular self-assembly, the tensile rate is affected by the dynamic intermolecular interactions, and trans-CHDA with a trans-structure has good dynamic recovery due to the intermolecular interactions in the most favorable arrangement. 60 mg of HMTA and 140 μL of water were added into 1 mL of AAc with the mass fraction of 28.6%, and then 100 μL of 10% APS was added. 60 mg of HMTA and 140 μL of water were added into 1 mL of MAAc with the mass fraction of 32.3%, and then 100 μL of 10% APS was added. The systems added with AAc and MAAc cannot be gelatinized (FIG. 11D). As a comparative example, HMTA proves that if the spatial arrangements of the amine groups cannot match with carboxylic acid chains through rotation of the C—C single bond for any reason, the gelation reaction will be severely hindered.

### Example 2

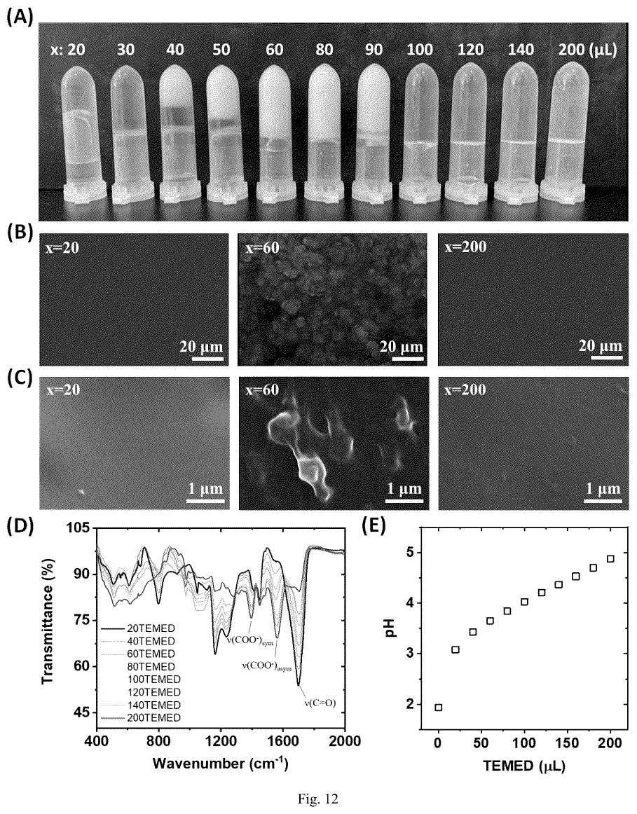

x μL of TEMED and (200-x) μL of water were added into 1 mL of AAc with a mass fraction of 28.6%, where x=20, 30, 40, 50, 60, 80, 90, 100, 120, 140 or 200; and then 100 μL of 10% APS was added. It can be observed that the prepared hydrogel changes from colorless and transparent to white, and then gradually becomes transparent (FIG. 12A). It can be observed through a fluorescence microscope that there are small granules with high brightness in a white hydrogel, but such a structure does not exist in a transparent hydrogel (FIG. 12B). It can be seen from a fluorescence intensity that there is a molecular structure with a high stacking density in a granular structure, which is caused by phase separation induced by hydrophobic interaction. Hydrophobic groups with a high density are accumulated inside the small granules. SEM results further prove observations in the fluorescence microscope (FIG. 12C). IR demonstrates that with an increased amount of TEMED, carboxyl groups change from neutral to ionic, thereby increasing the difficulty of forming hydrogen bonds with amine groups (FIG. 12D). The stretching vibration of C—O in the carboxyl groups is at 1701 cm-1 and the asymmetric and symmetric stretching vibrations of the carboxyl groups are at 1561 cm-1 and 1398 cm-1, respectively. Meanwhile, the pH of the system gradually increases with the addition of TEMED, which facilitates the dissociation of carboxylic acids (FIG. 12E).

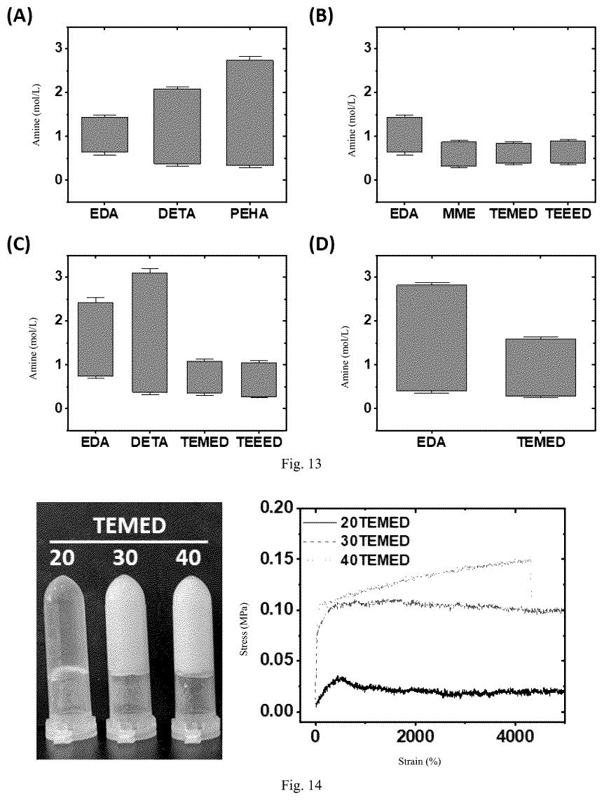

x μL of EDA/DETA/PEHA and (200-x) μL of water were added into 1 mL of AAc with the mass fraction of 28.6%, where x=20, 30, 40, 50, 60, 80, 90, 100, 120, 140, 160 or 200; and then 100 μL of 10% APS was added. After gelation, phase separation occurs inside the white hydrogel, and the hydrogel is opaque under the action of light scattering. It can be seen that with the increase of the structural chain length of the sliding wedge, the concentration range of the amine group that can generate phase separation increases dramatically (FIG. 13A), providing that a large chain length is conducive to phase separation. x μL of MME/TEMED/TEEED and (200-x) μL of water were added into 1 mL of AAc with the mass fraction of 28.6%, where x=20, 30, 40, 50, 60, 80, 90, 100, 120, 140, 160, or 200; and then 100 μL of 10% APS was added. It can be seen that when there are hydrophobic groups on the sliding wedge, the concentration range of the amine group that can generate phase separation is narrowed dramatically, but the lower concentration limit of amine that can perform phase separation is reduced (FIG. 13B). x μL of EDA/DETA/TEMED/TEEED and (200-x) μL of water were added into 1 mL of MAAc with the mass fraction of 32.3%, where x=20, 30, 40, 50, 60, 80, 90, 100, 120, 140, 160 or 200; and then 100 μL of 10% APS was added. As compared to FIG. 13A and FIG. 13B, it can be seen that when a hydrophobic group is attached to the carboxyl orthosite, the concentration range of the amine group that can generate phase separation is expanded dramatically. Results in FIG. 13B and FIG. 13C prove that the hydrophobic group can facilitate phase separation, and the generation of the hydrophobic domains is probably caused by winding the sliding wedge with the hydrophobic portion of the carboxylic acid chains. x μL of EDA/TEMED and (200-x) μL of water were added into 1 mL of FAAc with the mass fraction of 33.3%, where x=20, 30, 40, 50, 60, 80, 90, 100, 120, 140, 160 or 200; and then 100 μL of 10% APS was added. As compared to FIG. 13A and FIG. 13B, it can be seen that when an electron-withdrawing group is attached to the carboxyl orthosite, the concentration range of the amine group that can generate phase separation is expanded dramatically (FIG. 13D).

x μL of TEMED and (200-x) μL of water were added into 1 mL of FAAc with the mass fraction of 33.3%, where x=20, 30 or 40; and then 100 μL of 10% APS was added. It can be observed that the phase separation occurs in the systems with x=30 and 40 after gelation (FIG. 14). Tensile tests show that there is a sudden change in mechanical strength between the hydrogels in a case of x=20 and 30, and there is only a small change in mechanical strength between the hydrogels in a case of x=30 and 40, proving that the existence of the hydrophobic domains can greatly enhance the strength of the hydrogels.

### Example 3

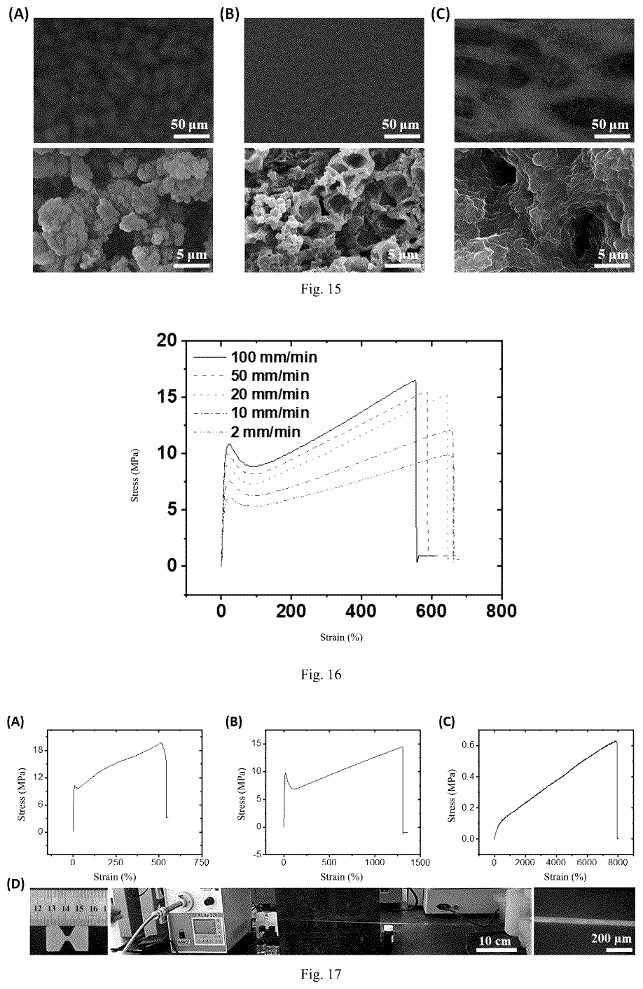

100 μL of TEEED and 100 μL of water were added into 1 mL of MAAc with a mass fraction of 32.3% was taken, and then 100 μL of 10% APS was added. The prepared hydrogel has a large granular structure when observed through a fluorescence microscope and a scanning electron microscope (SEM) (FIG. 15A). 50 μL of TEDETA and 150 μL of water were added into 1 mL of MAAc with the mass fraction of 32.3%, and then 100 μL of 10% APS was added. The prepared hydrogel has a network structure when observed through the fluorescence microscope and the scanning electron microscope (SEM) (FIG. 15B). 60 μL of TEMED and 140 μL of water were added into 1 mL of FAAc with the mass fraction of 33.3%, and then 100 μL of 10% APS was added. The prepared hydrogel has a fibrous structure with a macroscopic void when observed through the fluorescence microscope and the scanning electron microscope (SEM) (FIG. 15C). It is difficult to observe the formation of an advanced structure in a hydrogel system prepared with AAc, proving that the formation of the advanced structure requires the participation of hydrophobic groups and strong hydrogen bonds.

90 μL of TEDETA and 110 μL of water were added into 1 mL of MAAc with the mass fraction of 48.9%, and then 100 μL of 10% APS was added. A precursor was poured into the corresponding mold to prepare into a synapticula sample for a tensile test. It can be found that when the tensile rate changes from 100 mm/min to 2 mm/min, the characteristics of a stress-strain curve change obviously (FIG. 16). When the tensile rate is fast, there are obvious peak-like characteristics on the left side of the curve. The fast tensile rate indicates a high peak, and a rupture strain decreases accordingly. When the tensile rate decreases, a stress peak on the left side thereof decreases and the elasticity of the material is improved accordingly. This proves that although the strength of the advanced structure is high, the formation and recovery of the advanced structure are slow, and the dynamic characteristics thereof can be observed on the time scale of seconds. When stretched quickly, the advanced structure deforms and ruptures in a centralized manner, presenting large strength but hardly providing a large contribution to elasticity. When stretched slowly, the advanced structure deforms stepwise and reversibly, decreasing the contribution to strength and improving the contribution to elasticity.

### Example 4

Mechanical properties of an ultra-tough hydrogel can be adjusted by adjusting the hydrogel formulation within a wide range to meet different application requirements. 70 μL of cis-CHDA and 130 μL of water were added into 1 mL of MAAc with a mass fraction of 48.9%, and then 100 μL of 10% APS was added. A precursor was poured into the corresponding mold to prepare into a synapticula sample for tensile test, where the rupture strength of the synapticula sample is 19.6 MPa, the tensile elongation at rupture of the synapticula sample is 540%, and the rupture energy of the synapticula sample is 81.8 MJ/m³ (FIG. 17A); therefore, the sample has excellent stiffness. 60 μL of cis-CHDA and 140 μL of water were added into 1 mL of AAc with the mass fraction of 44.4%, and then 100 μL of 10% APS was added. A precursor was poured into the corresponding mold to prepare into a synapticula sample for a tensile test, where the rupture strength of the synapticula sample is 14.5 MPa, the tensile elongation at rupture of the synapticula sample is 1310%, and the rupture energy of the synapticula sample is 135.7 MJ/m³ (FIG. 17C); therefore, the sample has optimal toughness. 80 μL of PEHA and 120 μL of water were added into 1 mL of AAc with the mass fraction of 44.4%, and then 100 μL of 10% APS was added. A precursor was poured into the corresponding mold to prepare into a synapticula sample for tensile test, where the rupture strength of the synapticula sample is 632 MPa, the tensile elongation at rupture of the synapticula sample is 7950%, and the rupture energy of the synapticula sample is 29.3 MJ/m³ (FIG. 17C); therefore, the sample has excellent elasticity. 70 μL of HMTETA and 130 μL of water were added into 1 mL of AAc with the mass fraction of 44.4%, and then 100 μL of 10% APS was added. A precursor was poured into the corresponding mold to prepare into a synapticula sample for a tensile test. The tensile strength of the synapticula sample is approximately 150 kPa and the final tensile rate changes by more than 30,000%; filaments with a diameter of ˜60 μm can be formed after sample stretching (FIG. 17D). This is the highest tensile record of existing hydrogels.

The composition-property design of the ultra-tough hydrogel satisfies the following patterns:

(1) When the hydrogen donor and the hydrogen acceptor have similar hydrophobicity, the tensile strength of the hydrogel is high. Different concentrations of EDA and TEMED were added into 1 mL of AAc with the mass fraction of 44.4% respectively to prepare the hydrogel, and the prepared hydrogel was subjected to a tensile test. The maximum tensile strength of the hydrogel with EDA was up to 0.46 MPa, while the maximum tensile strength of the hydrogel with TEMED was only 0.2 MPa. Different concentrations of EDA and TEMED were added into 1 mL of MAAc with the mass fraction of 48.9% respectively to prepare the hydrogel, and the prepared hydrogel was subjected to a tensile test. The maximum tensile strength of the hydrogel with EDA was only 2.3 MPa, while the maximum tensile strength of the hydrogel with TEMED was up to 6.4 MPa.

(2) When the hydrogen donor and the hydrogen acceptor have different hydrophobicity, the elasticity of the hydrogel is improved. Different concentrations of DETA and PMDETA were added into 1 mL of AAc with the mass fraction of 44.4% respectively to prepare the hydrogel, and the prepared hydrogel was subjected to a tensile test. The maximum elongation at rupture of the hydrogel with DETA was 7818%, and the maximum elongation at rupture of the hydrogel with PMDETA was up to 30,000%.

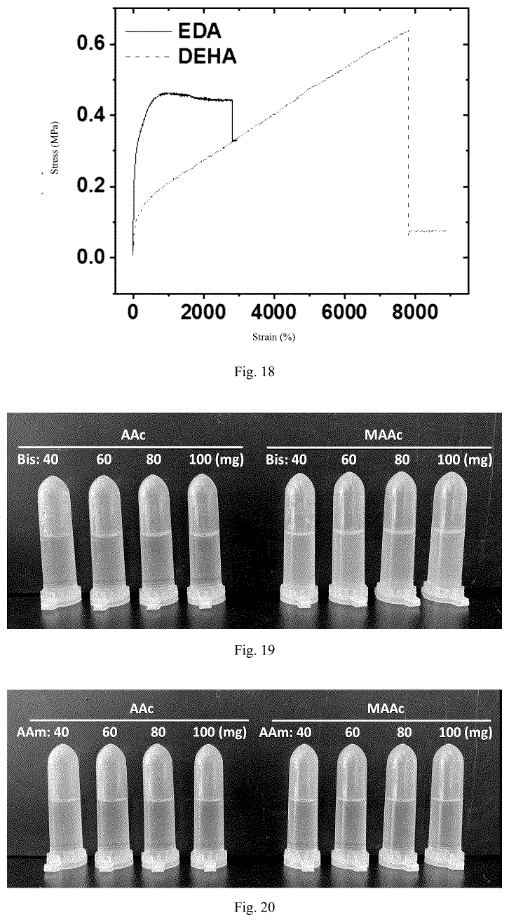

(3) When the same type of the hydrogen acceptor is lengthened, the comprehensive performance of the material is greatly improved, different concentrations of EDA and DETA were added into 1 mL of AAc with the mass fraction of 44.4% respectively to prepare the hydrogel; the prepared hydrogel was subjected to a tensile test; and the sample with the highest rupture energy was selected (FIG. 18).

### Comparative Example 1

x mg of N,N′-methylenebisacrylamide (Bis) and (200-x) μL of water were added into 1 mL of AAc with a mass fraction of 28.6%, where x=40, 60, 80, or 100; and then 100 μL of 10% APS was added. x mg of Bis and (200-x) μL of water were added into 1 mL of AAc with the mass fraction of 32.3%, where x=40, 60, 80, or 100; and then 100 μL of 10% APS was added. Bis is a common chemical crosslinker for the hydrogel. It can be observed that all the above systems cannot be gelatinized (FIG. 19), proving that the gelation of the present invention depends on the formation of a unique hierarchical energy associative dissipation network, and that conventional chemical crosslinkers are unable to achieve the gelation of the systems in the present invention.

### Comparative Example 2

x mg of acrylamide (AAm) and (200-x) μL of water were added into 1 mL of AAc with a mass fraction of 28.6%, where x=40, 60, 80, or 100; and then 100 μL of 10% APS was added. x mg of AAm and (200-x) μL of water were added into 1 mL of AAc with the mass fraction of 32.3%, where x=40, 60, 80, or 100; and then 100 μL of 10% APS was added. It can be observed that all the above systems cannot be gelatinized (FIG. 20), proving that the gelation of the present invention depends on the interaction between the carboxyl groups and the amine groups and that the use of amide groups cannot achieve gelation.

What is claimed is:

1. A method for preparing ultra-tough physical hydrogels based on hierarchical energy associative dissipation network, comprising the following steps:
(1) preparing a stock solution of a hydrogen donor: dissolving a hydrogen donor in deionized water to form the stock solution;
(2) mixing all reactants in an appropriate proportion: mixing the stock solution with a hydrogen acceptor, deionized water and a 10 wt % ammonium persulfate (APS) solution, to obtain a mixture and a molar ratio of the hydrogen donor to the hydrogen acceptor in the mixture ranges 9:1 to 5:6; and
(3) incubation: placing the mixture in a closed container until the mixture is fully cured;
wherein the hydrogen bond donor is acrylic acid and derivatives thereof; and the hydrogen bond acceptor used is small molecule organic amine.

2. The method according to claim 1, wherein in Step (1), a mass concentration of the stock solution is 25%-50%; in Step (2), for 1 mL of the stock solution, 0-190 μL of the deionized water, 10-200 μL of the hydrogen acceptor, and 100 μL of 10% ammonium persulfate (APS) solution are added.

3. The method according to claim 1, wherein in Step (3), incubation time varies according to different formulations, and is generally 5 min to 2 d.

4. The method according to claim 1, wherein in Step (3), if a hydrogel in a specific shape needs to be prepared, the mixture is poured into a corresponding mold, and cured.

5. The method according to claim 1, wherein the hydrogen donor is selected from acrylic acid (AAc), methacrylic acid (MAAc), and 2-fluoroacrylic acid (FAAc); and the hydrogen acceptor is selected from ethylenediamine (EDA), N, N-dimethylethylenediamine (DMED), N,N′-dimethyl-1,2-ethanediamine (MMED), N,N,N′-trimethylethylenediamine (DMMED), tetramethylethylenediamine (TEMED), N,N,N′,N′-tetraethylethylenediamine (TEEED), N,N,N′,N′-tetramethyl-1,3-propanediamine (TEMPD), diethylenetriamine (DETA), N,N,N′,N″,N″-pentamethyldiethylenetriamine (PMDETA), N,N,N′,N′-tetraethyldiethylenetriamine (TEDETA), 1,1,4,7,10,10-hexamethyltriethylenetetramine (HMTETA), pentaethylenehexamine (PEHA), cis-cyclohexane-1,2-diamine (cis-CHDA), and trans-cyclohexane-1,2-diamine (trans-CHDA).

6. An ultra-tough physical hydrogel prepared by the method according to claim 1, wherein a hierarchical self-assembly network spontaneously formed by in the hydrogel comprises: (1) a zipper like core (z-core), wherein the zipper like core is the primary self-assembly network and formed mainly on the hydrogen bonding among hydrogen donors and hydrogen acceptors; the formation of the zipper like core requires the specific arrangement of functional groups of, wherein adjacent carboxyl groups on a polymer chain need to be spaced by three carbon atoms; and the amine groups of hydrogen acceptor need to be spaced by two carbon atoms; the specific molecular architecture above allows the formation of a sliding wedge structure containing multidentate hydrogen bonding that simultaneously enables high-strength molecular interactions and great deformability; (2) hydrophobic domains, wherein hydrophobic groups in the reaction system are clustered through hydrophobic interactions and assembled into a supramolecular structure with a considerable associative strength, and the presence of the hydrophobic domains turns the hydrogel from a homogeneous structure into a heterogeneous structure; the hydrophobic domains are usually submicron-sized spheres or spheroids containing closely packed organic molecules, and therefore has a higher material density than surrounding media; and (3) advanced structures assembled from the hydrophobic domain, wherein hydrophobic domains matrices are further assembled into a complex advanced structure with a larger volume: the intermolecular hydrogen bonding and the further cluster of the hydrophobic groups are the main driven force of the process; and types of the advanced structures assembled by the hydrophobic domains comprise large particles, network structures, fibrous structures, and other structures.
